(19) United States
(12) Patent Application Publication
(10) Pub. No.: US 2011/0088632 A1
(43) Pub. Date: Apr. 21, 2011

(54) Closed-type ornamental aquarium

(75) Inventors: Naoto Ishikawa, Otsu-shi (JP); Yoichiro Sakai, Otsu-shi (JP); Ryohei Yamamoto, Miura-gun (JP); Naoyuki Izumi, Kyoto-shi (JP); Takaaki Nishida, Kyoto-shi (JP)

(73) Assignee: FUMOTO TRADING CO., LTD., Miura-gun (JP)

(21) Appl. No.: 12/806,043

(22) Filed: Aug. 3, 2010

(30) Foreign Application Priority Data
Aug. 7, 2009 (JP) 2009-184950

(51) Int. Cl. A01K 63/04

(52) U.S. Cl. 119/260

(57) ABSTRACT

The closed-type aquarium of the present invention includes a light transmissive container in which a vapor phase of air and a liquid phase of water are sealed. The liquid phase includes a shrimp, an aquatic plant and a microorganism. Further, to enhance efficiency of material recycling, the liquid phase includes a snail that has a different ecological niche than that of the shrimp and a plant dead body that supplements a resource essential for photosynthesis of the aquatic plant.

This application claims priority under 35 U.S.C. §119 from Japanese patent application Serial No. 2009-184950, filed Aug. 7, 2009, entitled “Closed-type ornamental aquarium,” which is incorporated herein by reference in its entirety.

### TECHNICAL FIELD

The present invention relates to an ornamental aquarium, and particularly, relates to a closed-type ornamental aquarium provided with an ecosystem.

### BACKGROUND OF THE INVENTION

Conventional ornamental aquariums are typically designed to accommodate fish, aquatic plants etc., in the aquarium and for enjoying the fish swimming around in the tank. Further, devices such as aerator to circulate air from outside into water in the aquarium or a device to purify water, a device to supply feed etc., are suitably installed, and fish etc. are cultivated. In such ornamental aquariums, within the existing domain of the organisms housed in the aquarium, it is possible to have fish and other organisms survive for prolonged periods. This is made possible by providing food from outside, or carrying out operations such as removing contaminated water, etc. from outside. Therefore, in conventional ornamental aquariums, when supply of feed or maintenance of water quality, etc. by the user cannot be guaranteed, maintaining a satisfactory living environment for the organisms in the aquarium becomes difficult, and it will not be possible to make them function as ornamental aquariums. Further, for reasons of humidity or odor, etc., conventional ornamental aquariums have limitations of their location. For example, hitherto it had been difficult to locate in libraries where it is necessary to maintain low humidity or hospitals and restaurants where hygiene environment is stringent.

In light of such problems, as ornamental aquariums in which the ecosystem is hosted in an aquarium that can be completely sealed, and in which external sustenance operations such as feeding or water change etc. are not required, commercial products called as Beach World or Ecosphere exist. The product is a closed-type ornamental aquarium, in which naturally growing microalgae and Scarlet shrimps are housed inside water completely sealed in a transparent vessel, and the sustenance of the shrimps is achieved by a food chain in which the shrimps feed on the microalgae, and the oxygen consumed by the Scarlet shrimps is produced by the microalgae by photosynthesis. Since it is a closed-type ornamental aquarium, there is no release of humidity or odor to outside. Incidentally, the closed-type ornamental aquarium mentioned here is an aquarium which is physically closed-system and is an open system in terms of energy.

In the closed-type ornamental aquarium, there is a problem of inability to remove detritus such as excrement and the residues etc., and not being able to supply the resources necessary for producer's photosynthesis from the outside of the system. To solve these problems, ideally, building an ecosystem in which all material recycling is done within the aquarium is necessary. That is, the ecosystem in which the followings are realized is necessary: a producer will produce oxygen and food resources that are essential for the survival of organisms by utilizing only the resources available within the aquarium; detritus that are toxic to the organisms are decomposed into resources that can be utilized by the producer and moreover, these two functions can be permanently sustained. The closed-type ornamental aquariums, for example Beach World (non-patent document 1), are based on this concept and have achieved such an ecosystem by simplifying the food chain.

As mentioned above, the Beach World uses Scarlett shrimps as consumers, microalgae as producers, and microorganisms as decomposers. In the system, it is so designed that the microalgae produce oxygen which the Scarlett shrimps and the microorganisms consume, the microalgae become the food source for the Scarlett shrimps and, in addition, the source required for the photosynthesis of the microalgae is provided by the decomposition action of the microorganisms.

However, there are no closed-type ornamental aquariums using shrimps that are bigger than Scarlett shrimps. This is because, since the quantity of oxygen consumed also increases with an increase in the body size of the organism, the amount of oxygen generated by the microalgae will not be able to support a bigger size shrimp. In such case, an aquatic plant (aquatic macrophyte) that produce more quantity of oxygen must be used.

In photosynthesis, aquatic plants require more photosynthetic substrate than microalgae do. In the closed-type aquarium, an aquatic plant can get the photosynthetic substrate only by decomposition of non-usable resources for the aquatic plant. (The non-usable resources mentioned here are the detritus such as excrement and residues, etc.) However, since the decomposition process requires time, this is equal to a shortage of the photosynthetic substrate in the short term. In the conventional closed-type ornamental aquariums, since detritus such as excrement and residues easily accumulate, and since the material recycling is disrupted, it will not be possible to sustain the production of aquatic plants. Therefore, till now it has been difficult to realize a closed-type ornamental aquarium employing aquatic plants.

The present invention provides a closed-type ornamental aquarium endowed with a system for prolonged sustenance of aquatic plant production, and in which shrimps larger in size than Scarlett shrimps can survive for a prolonged period.

### SUMMARY OF THE INVENTION

According to a first aspect of the present invention,

a closed-type aquarium includes:

a light transmissive container in which a vapor phase of air and a liquid phase of water are sealed,

wherein, the liquid phase includes a shrimp, an aquatic plant, a microorganism, and a snail whose food utilization pattern is different from that of the shrimp, and further, the liquid phase includes a plant dead body that supplements an essential resource for photosynthesis of the aquatic plant.

Although the shrimp feeds on the aquatic plant, the shrimp cannot consume all the aquatic plants. In the aquarium, non-usable resources such as aquatic plant dead body that was not consumed by the shrimp and excrement of the shrimp are generated. Moreover, these cannot be used for the photosynthesis of the aquatic plant. The non-usable resources are decomposed by the microorganism, and are returned to the system as inorganic nutrients that can be utilized by the aquatic plant. (As inorganic nutrients, nitrate, phosphate, silicate, etc can be cited.) It is normal that such microbial decomposition process occurs over several stages, and requires long time. Accordingly, these residual matters tend to accumulate inside the closed-type aquarium over time. Such type of partial disruption of material recycling is lethal for the closed-type aquarium. This is because, in the closed-type aquarium that is physically closed, and in which the resource quantity is constant, this means that these residual matters represent a reduction in the amount of usable resources available for the producer. Therefore, they become a factor for inhibiting the photosynthesis of the aquatic plant, which might lead not only to a reduction in the quantity of production of oxygen and the feed resources, but also to the death of the aquatic plant that is the foundation of the ecosystem.

Therefore, the first aspect of the present invention provides a configuration for improving the efficiency of material recycling in the ecosystem by creating a second food chain by introducing a snail that has a food resource utilization pattern different from that of shrimps. The snail referred herein must have a food resource utilization pattern that is different from that of shrimps. That is, the feeding patterns and feeding sites should be necessarily different from those of shrimps. The snail feeds on the remains or residue of the aquatic plant which the shrimp cannot feed on, excrement of shrimps, and the microorganisms breeding on the container wall or gravel, and recycle them as easily decomposable organic or inorganic nutrients into the system. Thus, by introducing a snail, another food chain is created by using the resources that the shrimp will not or cannot eat, and the material recycling efficiency within the system can be improved.

By the way, in the course of life activities, although organisms fix resources such as carbon, nitrogen, phosphorus, etc., in their body, part of them exists in a form that is not returned as an utilizable resource even with passage of time. Further, the life activities of organisms produce a large variety of organic materials that includes some materials that are difficult to be decomposed. As these refractory materials require prolonged time for decomposition, or require special conditions, this is as good as becoming fixed as an organism body. That is, with passage of time, the usable resource for the aquatic plant tends to decrease. Therefore, to sustain the ecosystem, a system to replenish the resources is necessary. However, introduction of a resource temporarily and in large amounts into a system might alter the system leading to a decline in life activities of shrimp and snail. Hence, it is necessary to supply a material into the system continuously as well as over prolonged period.

Thereupon, according to the first aspect of the present invention,

in the liquid phase, a plant dead body that replenishes the sources required for photosynthesis of the aquatic plant is included. The plant dead body referred herein is not the residue of the aquatic plant in the aquarium, but is intentionally introduced by the fabricator, and the residue of a land-based plant is preferred. The carbon resource contained in the plant dead body is used as a source of energy by aerobic microorganisms adhering to the surface of plant dead body, and released into the system as carbon dioxide by respiratory metabolism. Such aerobic microorganisms are known to often proliferate rapidly, causing a rapid decrease in the quantity of oxygen in the system. However, in the ecosystem of the present invention, a snail that feeds on the aerobic microorganism is also present. Therefore, because the microorganism decomposes the plant dead body and provides carbon resource in the system, while the snail suitably feeds on the microorganism, short-term overgrowth of the microorganism is suppressed. Further, the plant dead body also contains elements essential for the growth of the aquatic plant. These elements are eluted during microbial decomposition.

Such type of feeding of the aerobic microorganism by the snail has the effect of not only suppressing the growth of the aerobic microorganism but also hasten the supply of the carbon resource. Moreover, replenishment of the carbon resource by a route of differing rates of the respiratory metabolism of aerobic microorganism and the respiratory metabolism of snail makes it possible to continuously supply the plant dead body-derived resource.

As described above, in the present invention, the material recycling efficiency is enhanced by including one more food chain containing the snail that shows a food resource utilization pattern that is different from that of the shrimp in addition to the food chain comprised of the shrimp, the aquatic plant and the microorganism. Moreover, by making the resource supply process multitrophic with the inclusion of the plant dead body, a sustained supply of resources critical for the production of the aquatic plant can be maintained. Consequently, the photosynthesis of the aquatic plant can be sustained for prolonged periods.

In the first aspect of the present invention,

the respective biomasses of the shrimp, the snail and the aquatic plant may be determined such that a sum of total quantity of oxygen consumed by the shrimp and total quantity of oxygen consumed by the snail is not more than the gross primary production quantity of oxygen by the aquatic plant.

Because the aquatic plant in the light transmissive container can produce oxygen by photosynthesis, and the respective biomasses of the shrimp, the snail and the aquatic plant are determined such that the sum of the quantity of oxygen consumed by the shrimp and the snail is not more than the gross primary production quantity of oxygen by the aquatic plant, the oxygen in the liquid phase will not get exhausted. As it becomes possible to prevent the death of organisms due to oxygen deficiency, prolonged survival of the shrimp, the snail and the aquatic plant can be sustained.

In case of oxygen deficiency, the vapor phase functions as a reserve for supplying oxygen to the liquid phase. From the aspect of chemical equilibrium, if the oxygen in the liquid phase is consumed and decreases, oxygen from the vapor phase dissolves into the liquid phase. Further, if the oxygen produced by the aquatic plant during photo period is not completely consumed by various organisms, the unconsumed portion is transferred from the liquid phase to the vapor phase. In other words, the vapor phase functions as an oxygen pool. As the aquatic plant cannot produce oxygen during dark period, the vapor phase functions as a source for oxygen supply.

In the first aspect of the present invention,

in the said liquid phase, a decomposition process may be included in which the microorganism decomposes or absorbs a residue of the aquatic plant or excrement of the shrimp or the snail, thereby eliminating materials that are toxic to the shrimp or the snail and supplying a resource that is required for photosynthesis to the aquatic plant.

In addition, gravel contained in the liquid phase may be comprised of an aerobic layer and an anaerobic layer. In the process of eliminating the toxic materials, anaerobic microorganisms that inhabit anaerobic layer may be included. In order to prevent explosive growth of the anaerobic microorganisms, the snail may feed on the anaerobic microorganisms and also suitably disturb the anaerobic layer.

A residue of the aquatic plant or excrement of the shrimp and the snail are not used by shrimps, snail and aquatic plants, and thus accumulate in the system. The substances contained in the residue or the excrement, for example, ammonia, etc., are normally toxic to shrimps or snail, and excess accumulation is lethal for the organisms. Further, in the closed-type aquarium in which the quantity of resources is limited as in the present invention, accumulation of resources in the system that cannot be used by shrimps, snail or aquatic plants signifies a decline in the resources usable by the shrimps, the snail or the aquatic plants. The accumulation of resources also induces a decline in the production of aquatic plants and hunger in shrimps and snail, leading to cessation of the material recycle and system collapse.

Such a residue or excrement are absorbed/decomposed only in the course of use in the life activities of microorganisms, and converted to a resource for aquatic plants or feed for shrimps and snail. There exist two main routes for the absorption/decomposition, and both are essential for the recycling of resources.

The first is the absorption/decomposition by aerobic microorganisms inhabiting the aerobic layer. In the aerobic layer, the aerobic microorganisms use the residue and the excrement as food resources, and the microorganisms increase. In this process, carbon dioxide due to the microbial respiration, and materials such as nitrogen, phosphorus, etc. due to the excrement are discharged as inorganic nutrients. These materials are the essential resources for the photosynthesis of the aquatic plants, and become a part of aquatic plant. Consequently, the materials that could not be used by shrimps or snail are returned as a usable resource to the food chain. Further, the overgrowth microorganisms become a food resource for snail, and they are also designed to re-enter the material recycling.

On the other hand, in the anaerobic layer, in contrast to the aerobic layer, absorption/decomposition of toxic substances takes place by the activity of anaerobic microorganisms. Denitrification bacteria can be offered as representative anaerobic microorganisms. The denitrification bacteria grow by using the inorganic matter such as ammonia etc., which are extremely toxic to shrimps or snail, as food source. In this process, by converting the toxic ammonia into harmless nitrogen gas and discharging, the toxic matter is eliminated from the liquid phase. Thus, decomposition of resources that are toxic to and unusable by shrimps and snail in the aerobic layer and the anaerobic layer, and conversion of the resources into usable resources, are extremely important processes in the closed-type aquarium. Even if one of the decomposition and the conversion is lacking, material recycling does not proceed smoothly.

However, if the anaerobic layer increases and the aerobic layer decreases, a certain type of anaerobic microorganisms in the anaerobic layer increase. The certain type of anaerobic microorganisms utilize the resources that are toxic to and unusable by organisms such as shrimps, snail and aquatic plants, and convert the resources into more toxic materials. For example, methane-oxidizing bacteria and sulfate-reducing bacteria etc., belong to this anaerobic microorganisms. If these anaerobic microorganisms proliferate abnormally, toxic materials accumulate in the system, and not only the resources available to organisms decrease but also can be a direct cause of death.

Therefore, it was configured to suppress the anaerobic microorganisms by disturbance and feeding by the snail. The snail can crawl around freely within the liquid phase, and make the top of gravel as one of living environments. Occasionally, it may dive into the depths of gravel, and disrupt the environment in the gravel. Further, the snail can feed on the microorganisms inhabiting in the gravel. Therefore, by disturbing the gravels by snails, the range of the anaerobic layer is maintained constant, and the ratio of the aerobic layer to the anaerobic layer is maintained suitably. Further, it is configured that, through appropriate predation by the snail in the gravel, the overgrowth of the anaerobic microorganisms can be suppressed, the generation of toxic substances by the anaerobic microorganisms can be minimized, and the activity of other helpful microorganisms such as denitrification bacteria in the anaerobic layer can be maintained.

### BRIEF DESCRIPTION OF DRAWINGS

FIG. 1 is a schematic showing the ornamental aquarium of the present invention.

FIG. 2 is a schematic showing the material recycling in the artificial ecosystem.

FIG. 3 is a schematic showing the mechanism of preventing accumulation of detritus in the liquid phase.

FIG. 4 is a schematic of process of sustaining preferable environment in the liquid phase.

FIG. 5 is a schematic showing the resource supply process from the plant dead body in the liquid phase.

### DETAILED DESCRIPTION OF THE INVENTION

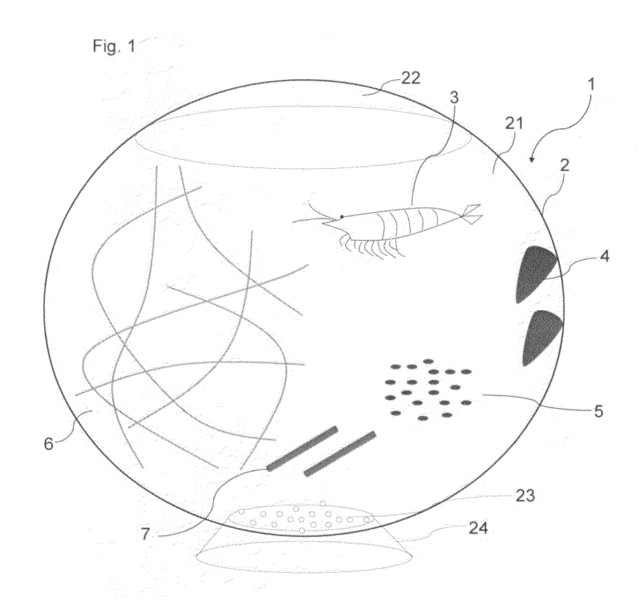

Below, an ideal embodiment of the invention is explained on the basis of accompanying figures. FIG. 1 is a schematic showing the configuration of the ornamental aquarium of the present invention. A closed-type ornamental aquarium 1 houses a liquid phase 21 of water, a vapor phase 22 of air and gravel 23 in a sealed container 2. The sealed container 2 is made of light transmissive material such as glass, acrylic, polycarbonate resin, etc. The container 2 may also be a partially transparent container with a configuration to permit sufficient shining of light onto the aquatic plant described later. The container 2 may be of any shape apart from spherical shape, rectangular shape, etc. A pedestal 24 is provided at the bottom of the container 2 for supporting the container 2.

In the liquid phase 21, a shrimp 3, a snail 4, a microorganism 5, an aquatic plant 6 and a plant dead body 7 are accommodated. The fabricator creates a closed-type aquarium by an appropriate combination of various organisms having the following features.

The shrimp 3 is included among Arthropoda, Crustacea, Malacostraca and Decapoda family, and can also be accommodated in the closed-type aquarium. The shrimp 3 exists as a consumer in the system, and feeds on the aquatic plant 6.

The snail 4 is included in the Mollusca Gastropoda family, can be accommodated in the closed-type aquarium, and has a food resource utilization pattern that is different from that of the shrimp. Concretely, it is that which feeds on part of the aquatic plant 6 or a plant dead body (however, it should not overlap the feeding sites of the shrimp), excrement of the shrimp and an adhering aerobic microorganism (algae that can adhere to the wall surface or microorganism that can adhere to the surface of the plant dead body 7). By demonstrating such a feeding habit, the snail 4 enhances the efficiency of material recycling by increasing the recycling of resources. Further, the snail 4 must be capable of descending into the gravel 23 and feed on the anaerobic microorganism. By being endowed with such behavioral features, the snail 4 has the effect of suppressing the propagation of the anaerobic microorganism.

The microorganism 5 decomposes/absorbs the excrement of the shrimp 3 and the snail 4 in the liquid phase 21, a residue of the aquatic plant, or the plant dead body 7. The inside of the gravel 23 is divided into an aerobic layer section and an anaerobic layer section. The anaerobic layer section contains the anaerobic microorganism critical for the decomposition process. Although the microorganism includes a variety of microorganisms, it is possible to largely classify as aerobic microorganisms and anaerobic microorganisms. Moreover, the aerobic microorganism contains microalgae which can perform photosynthesis.

The aquatic plant 6 absorbs the carbon dioxide and inorganic nutrients from the liquid phase, and produces oxygen by photosynthesis. Further, the aquatic plant 6 is a material which the shrimp 3 can feed on.

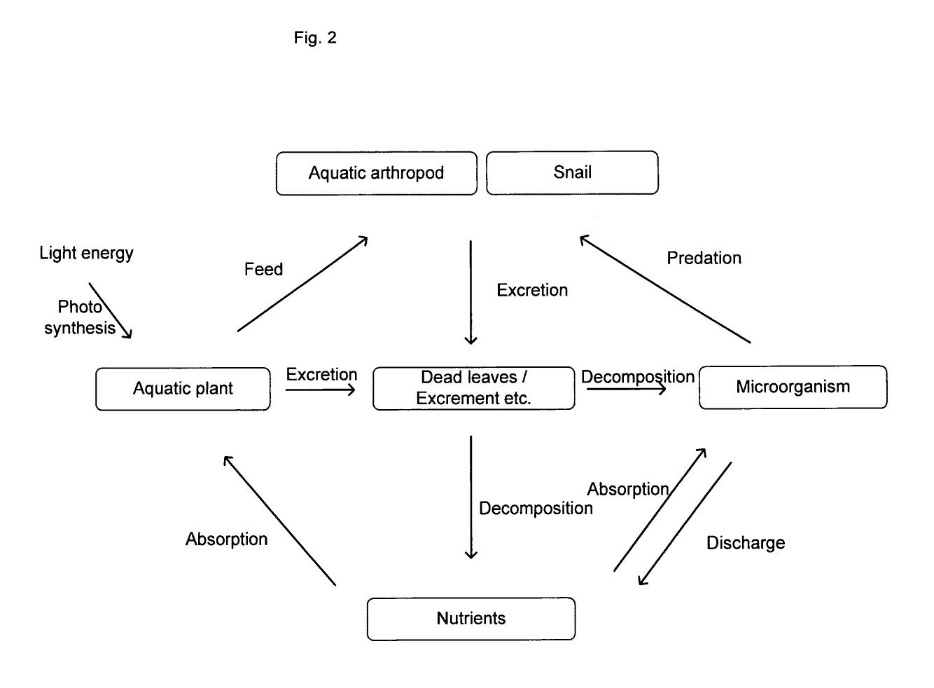

In such a configuration as above, the material recycling of the ecosystem in the aquarium will be explained with FIG. 2. A material recycling is completed, in which: the shrimp 3 feeds on the aquatic plant 6; the snail 4 feeds on part of the aquatic plant 6 which is not utilized by the shrimp 3 and also feeds on the microorganism 5; the microorganism 5 decomposes the excrement of the shrimp 3 and the snail 4 and the dead portion of the aquatic plant 6 and fixes in the body, or discharges as inorganic nutrients into the liquid phase; the aquatic plant 6 absorbs the nutrients eluting from the excrement of shrimp 3 and snail 4 or the dead portion of the aquatic plant 6, or absorbs the nutrients discharged by the microorganism 5, and performs photosynthesis by using the light energy.

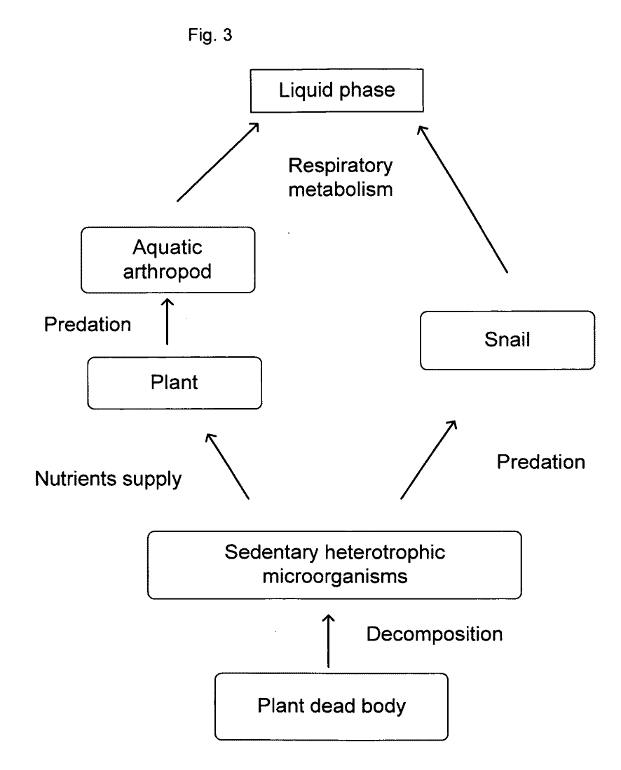

On the other hand, even when such a recycling of matter is established, the usable resources within the system decreases with passage of time. For sustaining the ecosystem, a system to replenish the resource in the system is necessary. However, if materials from the replenishing system are introduced temporarily and in large amounts into the system, the environment may get changed leading to a decline in the life activities of the shrimp 3 and the snail 4. Thus, it is necessary that the material supply into the system be done continuously. Therefore, as shown in FIG. 1, the plant dead body 7 was added into the liquid phase. However, the plant dead body 7 is different from the residue formed from the aquatic plant 6 in the aquarium. The plant dead body 7 is intentionally added by the fabricator. Further, a residue of a land-based plant is preferable as the plant dead body 7. The resource supply mechanism by the plant dead body will be explained based on FIG. 3. Since the carbon resources contained in the plant dead body is used only by organisms adhering to the surface of the plant dead body, the substances contained in the plant dead body are a resource that cannot be used by organisms other than this microorganism. The microorganism which propagates using the plant dead body converts the carbon present in the plant dead body into carbon dioxide via a respiratory metabolism and supplies it to the aquatic plant 6. Moreover, the snail feeding on this heterotrophic microorganism, along with suppressing the propagation of the microorganism, releases carbon dioxide by respiratory metabolism.

In the liquid phase 21, focusing attention on the oxygen metabolism of various organisms, the respective biomasses of the shrimp 3, the snail 4 and the aquatic plant 6 are specified such that the sum of the quantity of oxygen consumed by the shrimp 3 and the quantity of oxygen consumed by the snail 4 is not more than the gross primary production quantity of oxygen by the aquatic plant 6.

The inside of the liquid phase 21 is an environment of propagation for the shrimp 3 and the snail 4. Excessive accumulation of the carbon dioxide and inorganic nutrients such as nitric acid or phosphoric acid in the liquid phase 21 exacerbate the habitat of the shrimp 3 and the snail 4. In the ornamental aquarium 1 of the present invention, as shown in FIG. 2, by absorbing/storing the above-mentioned substances (carbon dioxide, nitric acid, phosphoric acid, etc.) present in the liquid phase 21 in the organism body by utilizing the food chain, and further recycling between the organisms, accumulation in the liquid phase 21 is prevented, and stabilization of the water quality for extended periods is made possible. Further, regarding attached algae that reduce the ornamental value, a configuration is made wherein the propagation of the attached algae is prevented by incorporating the snail that feeds on these. With this, there is hardly any propagation of algae, and it becomes possible to maintain the ornamental value.

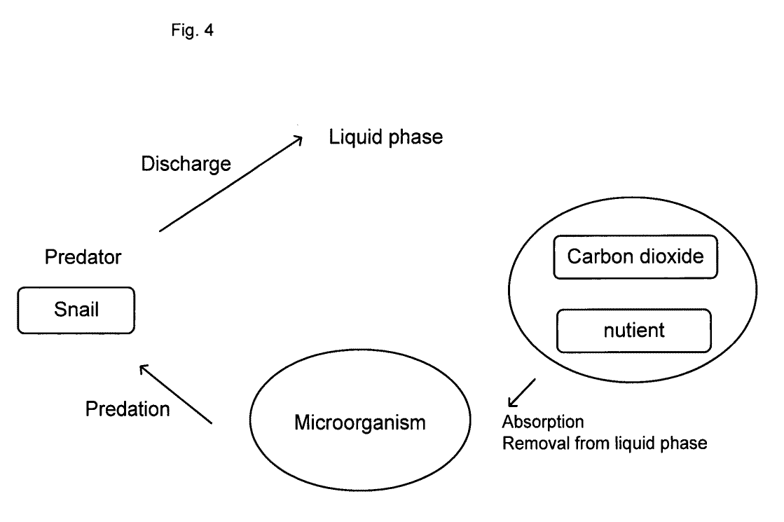

Regarding unexpected increase in the concentration of nutrient, as shown in FIG. 4, sustenance of a preferable environment is rendered possible by utilizing the rapid propagation of the microorganism 5 and the feeding pressure of the snail. By absorbing excess carbon dioxide with the microalgae included in the microorganism 5, the microalgae performs photosynthesis by using the carbon dioxide and light energy, and stores the carbon dioxide as organic matter in the body. Further, nitric acid, phosphoric acid, etc. discharged into the liquid phase 21 are removed from the liquid phase by rapid absorption by the aerobic microorganism. When the microorganism propagates via such a process, there is a possibility of consumption of large quantity of oxygen. Due to this, a large scale propagation of the microorganism is suppressed by the feeding pressure of the snail. Through such a process as above, even for short-term water quality deterioration, it will be possible to maintain an preferable environment of the liquid phase.

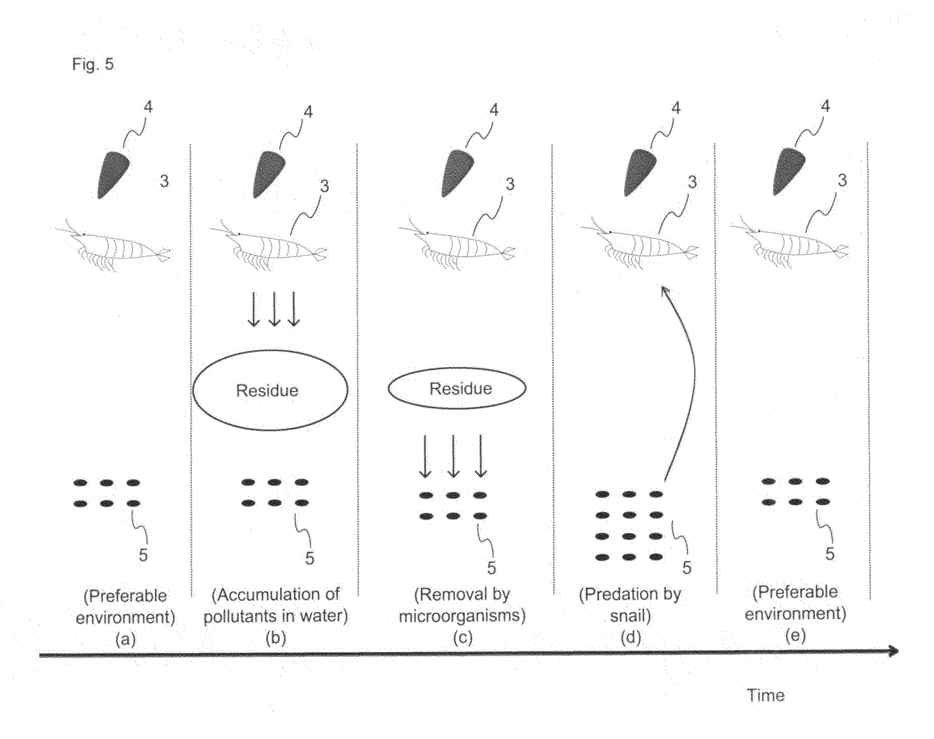

The process of the preferable environment sustenance for short-term water quality deterioration will be concretely explained with reference to FIG. 5. From a status of the preferable environment (FIG. 5(a)), detritus keep accumulating due to the excrement of the shrimp 3 and the snail 4 (FIG. 5(b)). As a result, the microorganism 5 which absorbs/decomposes these detritus increases (FIG. 5(c)). During this, due to increase of the microorganism 5, detritus decrease. Further, the increased microorganism 5 decreases due to predation by the snail 4 (FIG. 5(d)), and the original preferable environment is restored (FIG. 5(c)).

The preferred embodiment in the ornamental aquarium described above, is a container made of highly transparent materials such as glass or polycarbonate, and has a capacity in the range of 500-3000 ml, preferably 1500-2500 ml, and more preferably about 2000 ml. The liquid phase is in the range of 70-90% of the capacity of the aquarium, and more preferably about 80%. The reason for keeping the liquid phase not more than 90% is for maintaining the vapor phase at a minimum of 10% or more. Gravel that function as the anaerobic layer is placed in the range of 10 ml-100 ml, preferably about 50 ml, by using particles of 0.5-5 mm diameter.

Regarding the photo environment during use, satisfactory oxygen production does not occur if a light of 700-2000 lux is not shone for 8 hours to 16 hours, ideally it is desirable to shine a light of about 1500 lux for 12 hours.

If the temperature during use is less than 7° C. or more than 30° C., it becomes difficult for the organisms to survive; not less than 15° C. and not more than 25° C. is preferable, and about 18° C. is more preferable.

The respective constitutional elements in the liquid phase are as follows.

Shrimp: wet weight per animal is in the range of 30-500 mg, and total of about 500 mg is preferable. As a standard, a shrimp up to a size of a usual shrimp is preferable, and a shrimp of a size larger than a prawn is not suitable because of oversize.

Snail: wet weight per snail is in the range of 150 mg-350 mg, and total of about 1000 mg is preferable.

Aquatic plant: In the range of 500 mg-3000 mg, more preferably 1000-2000 mg.

Plant dead body: In the range of 50-400 mg, more preferably about 200 mg.

It is more preferable that the weight ratio of these is close to Shrimp:Snail:Aquatic plant:Plant dead body=10:5:10:2

Next, the respective constitutional elements are shown below with concrete examples.

Shrimp: Those belonging to Atyidae, Palaemonidae, Hippolytidae

Snail: Those belonging to Viviparidae, Pleuroceridae, Planorbidae, Lymnaeidae, and Physidae

Aquatic plant: Submerged plants (Najadaceae, Potamogetonaceae, Ceratophyllaceae, Haloragaceae, Cladophoraceae, Fontinalaceae, Hypnaceae, etc.)

Plant dead body: Herbaceous plants, and as an example can be offered, Poaceae, Leguminosae, Asteraceae, Orchidaceae, Rubiaceae, Euphorbiaceae, Cyperaceae, etc.

### Best Example

Vessel: Material Glass

Vessel capacity: 2000 ml

Vapor phase 350 ml

Liquid phase 1600 ml

Filter layer 50 ml

Shrimp: Minaminumaebi (Neocaridina denticulata) 500 mg

Snail Indian flat snail (Indoplanorbis exustus) 1000 mg

Aquatic plant: Common water moss (Fontinalis antipyretic) or Taxiphyllum barbieri 1000 mg

Plant dead body: Rice plant 200 mg

By fabricating an aquarium of the above configuration, under a condition of irradiating a light of 1400 lux for 12 hours and average room temperature of 20° C., a closed-type aquarium was maintained for 180 days without death of the aquatic plant.

What is claimed is:

1. A closed-type aquarium comprising:
a light transmissive container in which a vapor phase of air and a liquid phase of water are sealed,
wherein the liquid phase includes a shrimp, an aquatic plant, a microorganism, a snail whose food resource utilization pattern is different from that of the shrimp, and a plant dead body that supplements an essential resource for photosynthesis of the aquatic plant.

2. The closed-type aquarium according to claim 1, the liquid phase further comprising a food chain where the shrimp feeds on the microorganism that decomposes the plant dead body.

3. The closed-type aquarium according to claim 1, wherein respective initial biomasses of the shrimp, the snail and the aquatic plant are specified such that a sum of total quantity of oxygen consumed by the shrimp and total quantity of oxygen consumed by the snail is not more than the gross primary production quantity of oxygen by the aquatic plant.

4. The closed-type aquarium according to claim 1, the container further comprising gravel.

5. The closed-type aquarium according to claim 4, wherein
the gravel includes an aerobic layer and an anaerobic layer, and
the snail feeds on an anaerobic microorganism and disturbs the anaerobic layer.

6. The closed-type aquarium according to claim 1, the liquid phase further comprising a decomposition process in which the microorganism decomposes or absorbs a residue of the aquatic plant or excrement of the shrimp or the snail, thereby eliminating materials that are toxic to the shrimp or the snail and supplying a resource that is required for photosynthesis to the aquatic plant.
